(19) United States
(12) Patent Application Publication
(10) Pub. No.: US 2008/0201402 A1
(43) Pub. Date: Aug. 21, 2008

(54) Method and system for providing instructions and actions to a remote network monitoring/management agent during scheduled communications

(76) Inventors: Tony Petrilli, Ottawa (CA); Greg Smith, Mountain (CA)

Correspondence Address: Ditthavong Mori & Steiner, P.C., 918 Prince Street, Alexandria, VA, 22314, US

(21) Appl. No.: 10/957,750

(22) Filed: Oct. 5, 2004

Related U.S. Application Data
(60) Provisional application No. 60/508,264, filed on Oct. 6, 2003.

(51) Int. Cl. G06F 15/16

(52) U.S. Cl. 709/202

(57) ABSTRACT

A method and system for sending configuration and action-related instructions to a remote network monitoring agent. The invention accomplishes this through an entity referred to as a web service. The remote network monitoring agent initiates a connection to a controlling management unit and acquires configuration instructions and actions to be performed on network devices and systems such as computers, routers and switches.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### FIELD OF INVENTION

The invention relates in general to the field of network devices and systems monitoring and management, and more particularly, it relates to a method and system for providing instructions and actions to a remote network monitoring/management agent during scheduled communications.

### BACKGROUND

IT Service Providers and VARs provide network and system management services to clients. To become more efficient and generate more revenues, they require near real-time information in the form of error messages, and health and system utilization data from network devices and systems. They also require the ability to quickly customize this collection of data based on their customer's environment and demands, and perform automated actions on network devices and systems.

Contemporary systems user to monitor and manage computer systems and networks comprise control units that directly connect to the monitoring/management agents. These systems are wasteful with respect to the Internet: they reduce the efficiency of the communication medium by requiring continuous connections in order for the control unit to supply the monitoring agents with control instructions.

Also, having the control unit directly connect to the monitoring/management agent may lead to major security breaches, the need for firewall configurations, as well as to other setbacks.

Therefore, there is a need for a system to monitor and manage computer systems and networks while overcoming the limitations described above, as well as other limitations which will become apparent upon reading and understanding the description of the present invention which follows.

### SUMMARY OF THE INVENTION

To overcome the limitations of the prior art described above, the present invention accordingly provides adequate techniques for the monitoring and management of network devices and systems. It provides a method and system for providing instructions and actions to a remote network monitoring/management agent during scheduled communications.

In accordance with the present invention, there is provided a distributed system for the management of computer systems and networks, based on the principle of a plurality of autonomous management entities storing information arising from the monitoring of the said systems and networks until a pre-defined time period when this information is forwarded to a controlling management entity, wherein the universe of systems and networks managed is partitioned between each of the autonomous management entities.

The present invention provides the advantage of leveraging the communication medium between the management agents and the controlling management unit by allowing the connection between the two to be arbitrary.

The invention also provides the advantage of having the remote controlling management unit control, during the periodic communication periods, the monitoring and management actions performed by the management agents, as a result of the management agents requesting control instructions from the controlling management unit.

In accordance with a further embodiment of the present invention, there is provided A method for managing computer systems and networks, based on the principle of a plurality of autonomous management entities storing information arising from the monitoring of the said systems and networks until a pre-defined time period when this information is forwarded to a controlling management entity, wherein the universe of systems and networks managed is partitioned between each of the autonomous management entities.

Furthermore, the invention deals with the difficulty of connecting to a system which resides inside a client network due to security configurations required on firewalls.

### BRIEF DESCRIPTION OF THE INVENTION

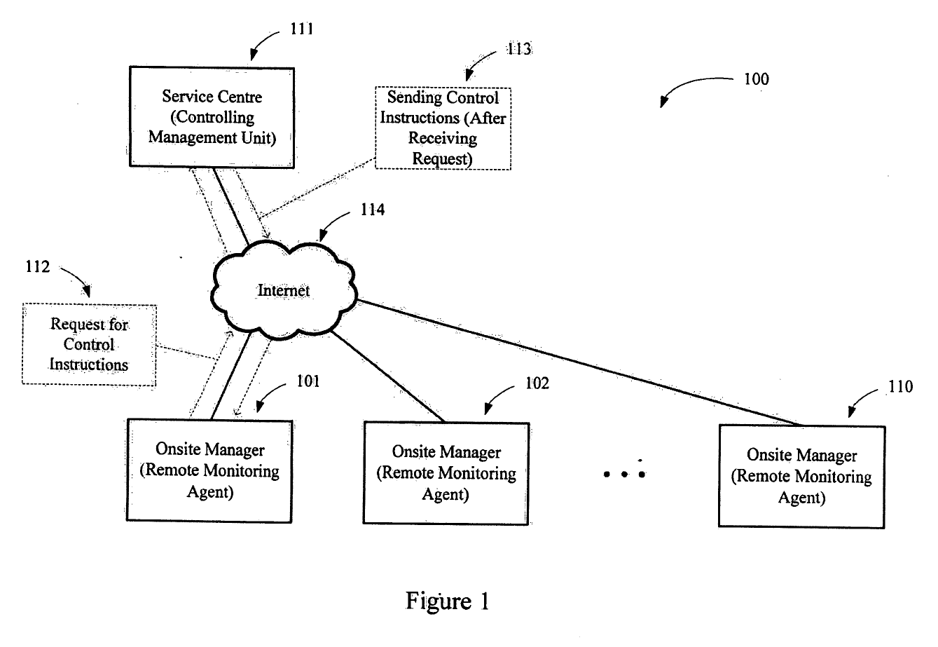

The invention, its organization, construction and operation will be best understood by reference to the following detailed description taken into conjunction with the accompanying drawing (FIG. 1), which is a block diagram illustrating a web-service architecture in accordance with the present invention, in which a remote agent acquires control instructions for the collection of information and automated actions to be performed on network devices and systems.

### DETAILED DESCRIPTION OF THE INVENTION

The following description is presented to enable any person skilled in the art to make use of the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the embodiments shown and described are only illustrative, not restrictive; and the present invention is to be accorded the widest scope consistent with the principles and features disclosed herein.

It will be generally understood that the terms “onsite manager,” “autonomous management entity,” “management agent,” “monitoring agent” and “remote agent” as used hereinafter are interchangeable. Also, it will be generally understood that the terms “service center,” “controlling management entity,” “controlling management unit” and “controlling unit” as used in this document are interchangeable.

In accordance with the present invention, there is provided a distributed system (100) for the management of computer systems and networks, based on the principle of a plurality of autonomous management entities (101-110) storing information arising from the monitoring of the said systems and networks until a pre-defined time period when this information is forwarded (112) to a controlling management entity (111), wherein the universe of systems and networks managed is partitioned between each of the autonomous management entities (101-110).

In the present invention, the remote controlling management unit (111) controls, during the periodic communication periods, the monitoring and management actions performed by the management agents (101-110), as a result of the management agents (101-110) requesting control instructions (112) from the controlling management unit (111).

The type of information gathered as a result of the monitoring actions performed by the management agents (101-110) is determined by these control instructions (112), and the extent to which the management agents (101-110) filter, condense, or summarize information prior to forwarding said information to the controlling management agent is also determined by these control instructions (112).

The present invention leverages the communication medium (114) between the management agents (101-110) and the controlling management unit (111) by allowing the connection between the two to be arbitrary—in other words, the connection may or may not be permanently established between communication periods.

The communications between the management agents (101-110) and the controlling management unit (111) are on a one-way basis: the management agents (101-110) connect to the controlling management unit (111) to request control instructions (112). The management agent connects every 5 minutes to the controlling management unit (111) and checks for these control instructions. If new control instructions are available, it downloads these instructions (113) in XML format (discussed below) and inserts said instructions in the local database. These new instructions now initiate the collection of data and automated actions which the remote monitoring/management agent now performs on the network devices and computer systems.

Collection of data includes, but is not limited to, error messages, performance data points, process and service status, and utilization data points. Automated actions to be performed on remote devices and systems include, but are not limited to, reboot systems, restart services, and run scripts or custom programs.

Extensible markup language (XML) is a language used to describe information, or more accurately, to make information self-describing. Traditionally, web pages are built using hypertext markup language (HTML). HTML describes the geometry and appearance of a page of data, in effect, creating holes or slots in which data is inserted. However, there is no direct communication of the data that appears on the page in the HTML description. A user might be presented with a page that includes recognizable information, such as name, address, and phone number; but to HTML, the data is simply text to display.

On the other hand, XML provides a protocol where the type of data being used can be identified. XML can do this in part using predefined “schemas” that can be used to understand the type of data being transmitted. If a standard schema is used, the data need only include a reference to the schema, which need not travel with the data-if a custom schema is used, it can be sent before or after the data, or explicit directions to the location of the schema can be provided.

The invention can take full advantage of XML-based services, and is also applicable for use with any service for which communication protocols can be established.

In order to provide a better understanding of the present invention, the following describes an implementation of the present invention:

The invention can be implemented to provide the tools VARs and IT service providers need to create more efficient services, higher profits, and more satisfied customers.

The invention is a distributed system comprising an onsite manager (101-110) at each customer site, and a service center (111) at the central site, connected by a secure outbound connection. The service center (111) comprises a central, consolidated dashboard containing data from all customer networks. It receives reports and alerts on the health of customer networks, and in turn, updates the dashboard, prioritizes alerts, and generates newly created trouble tickets as required.

The local onsite manager agent (101-110) monitors all IP devices at a customer's site. The onsite manager (101-110) expert system component then filters and processes all data and sends this critical network health data-using a secure Internet connection—to the service center (111). These alerts are then displayed on the central dashboard status screen for immediate attention and speedy resolution.

This secure Internet connection uses standard web access (HTTP/HTTPS) coupled with XMUSOAP protocols for a one-way outbound communication, regardless of the connection at the end-customer's site—whether it's simple dial-up or broadband.

The onsite manager (101-110) can monitor the following devices and events: network devices and systems, systems and network performance, and customizable event logs.

Network Devices and Systems: Using SNMP and ICMP, the onsite manager (101-110) can monitor a wide range of critical network factors from device heartbeat and event logs to key performance indicators. The onsite manager (101-110) monitors all servers, workstations, and network devices such as routers, managed switches, printers, and others.

On initial discovery, an administrator selects the devices they wish to monitor and configures the information to gather. This data is processed by the expert system, which filters, triages, and prioritizes before sending it to the service center (111) from the local onsite manager (101-110).

Systems and Network Performance: From the central console, an IT service provider can quickly see the performance of an entire site down to a single machine. The onsite manager (101-110) will collect detailed performance data locally from servers and workstations on such core system components as CPU, memory, and BIOS.

Customizable Event Logs: the onsite manager (101-110) provides full windows event monitoring and user-definable events. IT service providers can receive alerts based on the default events in the system, application, and security logs. They can also receive alerts based on business requirements.

The onsite manager (101-110) escalates alerts for events or failures to the service center (111), and hence, to the responsible technician. These alerts appear on the service center central dashboard, and can be color-coded for quick and easy visual assessment. The appropriate support person can be notified of the alert by any web or email enabled device.

The web-based reports can be combined with incident records to provide end users with easy explanations for fluctuations in their environment. The performance reports can be monitored in many ways allowing analysis on hourly, daily, weekly, monthly, or quarterly basis. These reports provide fact-based capacity management and demonstrative service level compliance data back to customers.

These reports are automatically generated from the information gathered. Because the reports are web based, they can be viewed by the IT service provider at their central site, by distributed technicians and sales staff, or even their customers if the feature is enabled.

The onsite manager (101-110) uses auto-discovery and auto-generation technology (WMI and SNMP) to collect essential network data. This inventory is collected at regular user-defined intervals, and ensures that both the IT service provider and their customers always have access to up-to-date inventory information.

In summary, the invention provides a method and apparatus for sending configuration and action-related instructions (113) to a remote network monitoring agent (101-110). The invention accomplishes this through an entity referred to as a web service. The remote network monitoring agent (101-110) initiates a connection to a controlling management unit (111) and acquires configuration instructions and actions to be performed (112), both in XML format, on network devices such as computers, routers and switches. The monitoring agent (101-110) connects to the controlling unit (112) at the pre-defined times, checks for new control instructions, and downloads these new instructions to re-configure itself (113).

The embodiments of the invention in which an exclusive property or privilege is claimed are defined as follows:

1. A distributed system for the management of computer systems and networks, based on the principle of a plurality of autonomous management entities storing information arising from the monitoring of the said systems and networks until a pre-defined time period when this information is forwarded to a controlling management entity, wherein the universe of systems and networks managed is partitioned between each of the autonomous management entities.

2. The system of claim 1, wherein the communication between the autonomous management entities and the controlling management entity is one-way, and initiated only by the autonomous management entities at the pre-defined times.

3. The system of claim 1, wherein the communication medium between the autonomous management entities and the controlling management entity is arbitrary.

4. The system of claim 3, wherein the monitoring and management actions performed by the autonomous management entities are remotely controlled by the controlling management entity during the periodic communication periods as a result of the autonomous management entities requesting control instructions from the controlling management entity.

5. The system of claim 4, wherein the type of information gathered as a result of the monitoring actions performed by the autonomous management entities is determined by the control instructions.

6. The system of claim 4, wherein the type of actions the autonomous management entities perform is also determined by the control instructions.

7. A method for managing computer systems and networks, based on the principle of a plurality of autonomous management entities storing information arising from the monitoring of the said systems and networks until a pre-defined time period when this information is forwarded to a controlling management entity, wherein the universe of systems and networks managed is partitioned between each of the autonomous management entities.

8. The method of claim 7, wherein the communication between the autonomous management entities and the controlling management entity is one-way, and initiated only by the autonomous management entities at the pre-defined times.

9. The method of claim 7, wherein the communication medium between the autonomous management entities and the controlling management entity is arbitrary.

10. The method of claim 9, wherein the monitoring and management actions performed by the autonomous management entities are remotely controlled by the controlling management entity during the periodic communication periods as a result of the autonomous management entities requesting control instructions from the controlling management entity.

11. The method of claim 10, wherein the type of information gathered as a result of the monitoring actions performed by the autonomous management entities is determined by the control instructions.

12. The method of claim 10, wherein the type of actions the autonomous management entities perform is also determined by the control instructions.
